(19) United States
(12) Patent Application Publication
(10) Pub. No.: US 2026/0322679 A1
(43) Pub. Date: Oct. 15, 2026

(54) METHOD AND SYSTEM TO IMPLEMENT ADAPTIVE FAULT REMEDIATION IN A NETWORK

(71) Applicant: Telefonaktiebolaget LM Ericsson (publ), Stockholm (SE)

(72) Inventors: Chunyan FU, Pointe-Claire (CA); Fetahi WUHIB, Pincourt (CA)

(73) Assignee: Telefonaktiebolaget LM Ericsson (publ), Stockholm (SE)

(21) Appl. No.: 19/111,057

(22) PCT Filed: Sep. 15, 2022
(86) PCT No.: PCT/IB2022/058725

§ 371 Date: Mar. 12, 2025

(51) Int. Cl. H04L 41/0654

(52) U.S. Cl. CPC H04L 41/0654

(57) ABSTRACT

Embodiments include methods, network nodes, storage medium, and computer program to implement adaptive fault remediation in a network. In one embodiment, a method comprises: receiving a fault remediation request to mitigate a fault of the network, the fault remediation request indicating one or more system components associated with the fault; performing a set of remediation actions on a corresponding set of system components within the network responsive to the fault remediation request, a remediation action within the set of remediation actions being selected based on a set of remediation constraints and a distance between the remediation action and the fault; and calculating for a performed remediation action within the set of remediation actions, a score for the performed remediation action upon performing the remediation action to evaluate an efficiency of the performed remediation action.

### TECHNICAL FIELD

Embodiments of the invention relate to the field of fault remediation; and more specifically, to implementing adaptive fault remediation in a network.

### BACKGROUND ART

Mission critical fifth generation (5G) applications are expected to be highly reliable, always available with a guaranteed quality of service (QoS). Applications deployed in 5G cloud systems may suffer from performance degradations or service interruptions, caused by various reasons such as infrastructure problem, traffic surge, and scheduling problem. Traditional data center uses techniques such as High Availability (e.g., adding redundant nodes) and Fault Tolerance (e.g., using check point and fall back), to ensure the reliability of the service. However, these techniques are difficult to deploy in distributed, heterogenous 5G edge infrastructure.

Artificial intelligence and machine learning (AL/ML) technologies may be used to detect or predict cloud infrastructure faults, which provide a possibility for timely or preventive management of faults. Once a fault is detected or predicted, a root cause analysis can be performed through techniques such as building a Bayesian network, where all anomalies that occurred following and prior to the detected/predicted fault are analyzed and their relationships identified. Using this information, possible paths leading to the detected/predicted fault could thus be identified.

With a detected/predicted fault and its root cause, actions need to be taken to remediate the occurred fault or prevent the fault from occurring. It is challenging to select actions that can remediate all the impacted system components of a network (which may include cloud system(s) and/or wireless/wireline networks) while fulfilling the resource and time requirements of different services in the network. Such challenges are multiplied as the network includes heterogenous cloud infrastructures and the characteristics of the traffic in the network fluctuate dynamically.

### SUMMARY OF THE INVENTION

Embodiments include methods, network nodes, storage medium, and computer program to implement adaptive fault remediation in a network. In one embodiment, a method comprises: receiving a fault remediation request to mitigate a fault of the network, the fault remediation request indicating one or more system components associated with the fault; performing a set of remediation actions on a corresponding set of system components within the network responsive to the fault remediation request, a remediation action within the set of remediation actions being selected based on a set of remediation constraints and a distance between the remediation action and the fault; and calculating for a performed remediation action within the set of remediation actions, a score for the performed remediation action upon performing the remediation action to evaluate an efficiency of the performed remediation action.

In one embodiment, an electronic device comprises a processor and machine-readable storage medium that provides instructions that, when executed by the processor, are capable of causing the processor to perform: receiving a fault remediation request to mitigate a fault of the network, the fault remediation request indicating one or more system components associated with the fault; performing a set of remediation actions on a corresponding set of system components within the network responsive to the fault remediation request, a remediation action within the set of remediation actions being selected based on a set of remediation constraints and a distance between the remediation action and the fault; and calculating for a performed remediation action within the set of remediation actions, a score for the performed remediation action upon performing the remediation action to evaluate an efficiency of the performed remediation action.

In one embodiment, a machine-readable storage medium that provides instructions that, when executed, are capable of causing a processor to perform: receiving a fault remediation request to mitigate a fault of the network, the fault remediation request indicating one or more system components associated with the fault; performing a set of remediation actions on a corresponding set of system components within the network responsive to the fault remediation request, a remediation action within the set of remediation actions being selected based on a set of remediation constraints and a distance between the remediation action and the fault; and calculating for a performed remediation action within the set of remediation actions, a score for the performed remediation action upon performing the remediation action to evaluate an efficiency of the performed remediation action.

By implementing embodiments as described, the performed one or more remediation actions not only remediate a faulty system component, but also heal the impacted system components. Additionally, multiple remedial actions may be applied to different system components at the same time or one by one in some embodiments, and the probability of the remediation success is greatly increased compared to earlier approaches. Furthermore, resource and time usage of a remediation action is considered as part of the criteria for evaluating the effectiveness of the remediation action so that the remediation can be adaptive to the current environment.

### BRIEF DESCRIPTION OF THE DRAWINGS

The invention may be best understood by referring to the following description and accompanying drawings that are used to illustrate embodiments of the invention. In the drawings:

FIG. 1 illustrates the input/output and the functional components in a remediation agent per some embodiments.

FIG. 2 illustrates an architecture where a remediation agent provides a remediation service per some embodiments.

FIG. 3 illustrates operations of a deployment architecture in which a remediation agent operates in offline training mode per some embodiments.

FIG. 4 illustrates operations of handling a training request per some embodiments.

FIG. 5 illustrates operations of handling a remediation request per some embodiments.

FIGS. 6A-6B illustrate operations of two online learning approaches to handle a remediation request per some embodiments.

FIG. 7 illustrates operations of an action selection agent to select actions per some embodiments.

FIG. 8 illustrates a state machine of a fault/action binding memory per some embodiments.

FIG. 9 is a flow diagram illustration of the operations to implement adaptive fault remediation in a network per some embodiments.

FIG. 10 illustrates an example of a remediation process per some embodiments.

FIG. 11 illustrates an electronic device implementing adaptive fault remediation per some embodiments.

FIG. 12 illustrates an example of a communication system in accordance with some embodiments.

FIG. 13 illustrates a user equipment per some embodiments.

FIG. 14 illustrates a network node per some embodiments.

FIG. 15 is a block diagram of a host, which may be an embodiment of the host 1216 of FIG. 12, per various aspects described herein.

FIG. 16 is a block diagram illustrating a virtualization environment in which functions implemented by some embodiments may be virtualized.

FIG. 17 illustrates a communication diagram of a host communicating via a network node with a UE over a partially wireless connection per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Embodiments of the invention aim at a remediating occurred fault or prevent a fault from occurring in a network, including cloud system(s) and/or wireless/wireline networks. The challenges of such remediation are in multiple fronts:

(1) The challenge of selecting one or more actions that can remediate all the impacted system components. Fault can propagate and create impacts on multiple system components. For example, a fault of computing resource over utilization (e.g., central/graphics processing unit (CPU/GPU) usage >90%) in a cloud server can lead to a lack of resources for software containers (also referred to as containers herein) running on the server. It may also cause the high packet loss in the software containers, and thus lead to the high application response delay. In such a case, taking actions such as restarting the containers or reconfiguring the application might not solve all the problems.

(2) The challenge of selecting appropriate actions that do not only heal the system, but also fulfill the resource and time requirements. Operators have different requirements for different cases. For example, problem solving time is the key measurement to implement mission critical services in normal operation, while optimal resource utilization may become more important when a network (such as an edge cloud) operates with resource constraints.

(3) The challenge of automating the action selection (without human intervention) on a large scale and in a highly dynamic cloud/network environment, where human expert-based decision-making may become infeasible. Note that the heterogeneity of cloud/network infrastructure and the dynamicity of traffic add more complexities, e.g., a proper action taken on one cloud site at one time might not be the best choice for another site or another time.

The existing solutions do not address these challenges. For example, earlier cloud fault prevention solutions use a simple logic to determine the action to apply, which cannot be used in large scale, heterogeneous edge cloud environment. Latter remediation solutions based on knowledge base (KB) assume that there is a knowledge base of recommended actions for specific faults. The knowledge base generally relies on a human expert to build, and one knowledge base might not be suitable to diverse environments. Even when an existing action in a knowledge base can be updated by run time experience, the learning is limited to existing actions, and adding actions to the knowledge base to remediate a new fault in the network is not addressed.

### Remediation Agent Based Solutions

Embodiments of the invention automatically select one or more actions for remediating a detected or predicted fault in a network, including cloud system(s) and/or wireless/wireline networks. In some embodiments, a remediation agent is responsible for processing remediation requests, with the input parameters including a detected/predicted fault, root cause path for the fault, the remediation policy, and the possible remediation actions. The remediation agent then identifies and performs the selected remediation actions. Note while the remediation agent aims at eliminating the impact of the detected or predicted fault and remediating the detected and/or preventing the predicted fault from happening, the remediation agent may select actions to reduce the impact of the detected or predicted fault without eliminating the impact in some embodiments, in which case the remediation action may be also referred to as a mitigation action.

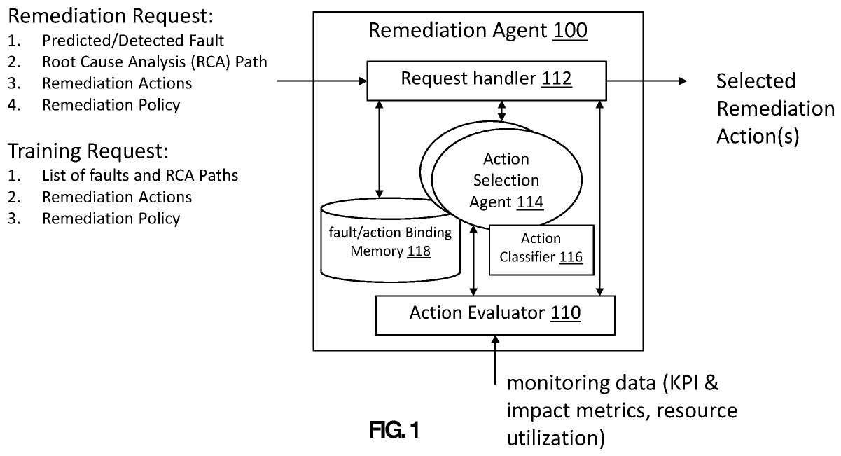

FIG. 1 illustrates the input/output and the functional components in a remediation agent per some embodiments. A remediation agent 100 may be implemented as a software module or hardware logic in an electronic device of a network.

The remediation agent 100 includes a request handler 112 to handle requests, including remediation requests and training requests. Upon receiving a remediation request, the request handler 112 may trigger an action selection by an action selection agent 114, output the selected actions for execution, evaluate the actions using an action evaluator 110 after the actions are executed, and update the fault/action binding memory 118 if necessary. In some embodiments, a remediation request includes (1) a predicted or detected fault, (2) a root cause analysis (RCA) path, (3) a set of remediation actions, and (4) a remediation policy. Upon receiving a training request, the request handler may trigger action selections for a set of faults. It may initiate one or more action selection agents 114 that may select actions and save successful fault/action bindings in the fault/action binding memory 118 for each fault, as explained in further detail herein below. Note records of the fault/action bindings may be stored in the fault/action binding memory 118 in a variety of databases (e.g., relational database, mongo database, Hadoop database) and datastores.

In some embodiments, a training request may include (1) a list of faults and an RCA path, (2) remediation actions, and (3) a remediation policy. In some embodiments, the action selection agent 114 is responsible for selecting actions for a specific fault. The process of the action selection is inspired by clonal selection, discussed in more details herein below. During the selection, the action selection agent 114 first classifies all the actions using the action classifier 116 in some embodiments. The actions belonging to the same class are called affinity actions, which should have similar costs and produce similar impact on the network. The action classifier 116 may be implemented using some machine learning classifiers or it can be some classification function developed by a human expert.

The action selection agent 114 may then select the class of actions, based on the average distance between the class of actions and a fault indicated by a request (examples of the distance function are discussed in more detail herein below). With the selected class of actions, the action selection agent 114 may test each action for a given fault, evaluate the effectiveness of the actions using the action evaluator 110 and finally output the action with shortest distance to the fault.

In some embodiments, the action evaluator 110 evaluates an action by first collecting the application quality of service (QoS), the resource and time utilization data for the action and checking whether it complies with the remediation policy. The action evaluator 110 then collects the monitoring data for the Key Performance Indicators (KPIs) and/or the metrics that was impacted (or to be impacted in the fault prediction case) by the fault and examines if the KPI is fulfilled and the metrics are in the normal range. With all the information, the action evaluator 110 may calculate and output a score for the current execution, where examples of the score function are discussed in more detail herein below.

In some embodiments, the fault/action binding memory 118 stores the historical successful fault/action bindings. A binding record can be initialized by human experts, or it can be generated by a training process as discussed herein. Once a memory is built, it can be shared and used by the request handler 112 for action selection. The memory is also updated each time when an action is executed. Different from the traditional data storage, the memory only remembers a binding for a period of time if there is no new update to the binding in some embodiments. This allows the solution to keep evolving and adapt to the dynamic edge cloud environment (e.g., an edge server or a base station in a wireless network) and save storage space. While the fault/action binding memory 118 is shown as within the remediation agent 100, it may be implemented as a storage apart from and coupled to the remediation agent 100 in some embodiments.

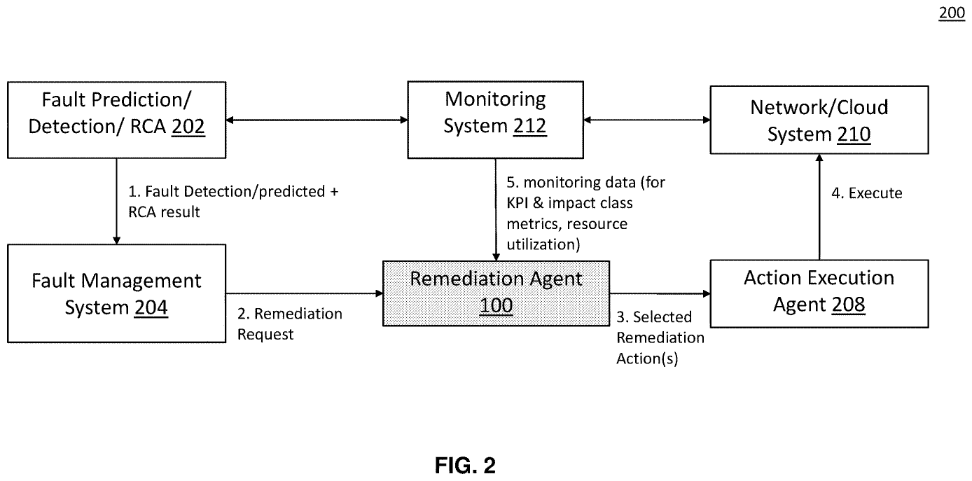

In some embodiments, the remediation agent 100 may provide one or more services to (1) a cloud management system for recovering the cloud system and/or (2) an orchestration layer of a wireless/wireline network (e.g., a software-defined networking (SDN) system, when there is a detected or predicted fault as shown in FIG. 2, and it may operate in two different modes: online remediation and offline training.

### Online Remediation

FIG. 2 illustrates an architecture where a remediation agent provides a remediation service per some embodiments. The architecture includes software modules and/or hardware logic in a system 200, where remediation services are provided to a (wireless/wireline) network/cloud system 210. The steps shown with numeric numbers 1 to 5 indicate the order of operations in one embodiment.

At step 1, a fault detection or prediction event, together with the root cause analysis (RCA) result is generated by a fault detection/prediction logic and/or RCA logic 202. A remediation request is then transmitted to a fault management system 204 at step 2 responsively. In some embodiments, in addition to the fault and root cause analysis path, the remediation request also provides a set of possible remediation actions and a remediation policy.

The remediation agent 100 selects one or more actions and requests an action execution agent 208 to execute them at step 3. The action execution agent 208 is responsible for mapping the one or more actions to one or more command(s)/instructions to operate on the network and/or cloud system at step 4. After one action is executed, the remediation agent 100 may evaluate the effectiveness of the one or more actions via analyzing the monitoring data collected from a monitoring system 212 at step 5. When more than one action is selected for a given fault, steps 3 to 5 may be repeated once per action in some embodiments, either in parallel or in sequence.

A remediation agent can learn the fault and action bindings online (operating in online remediation mode). However, the process can take a long time, and it may also consume a significant amount of resource for trial and error, which might not be acceptable for mission critical applications deployed in a network/cloud system. Before onboarding a remediation agent to a live network, the remediation agent may be trained with known faults in an offline training mode.

### Offline Training

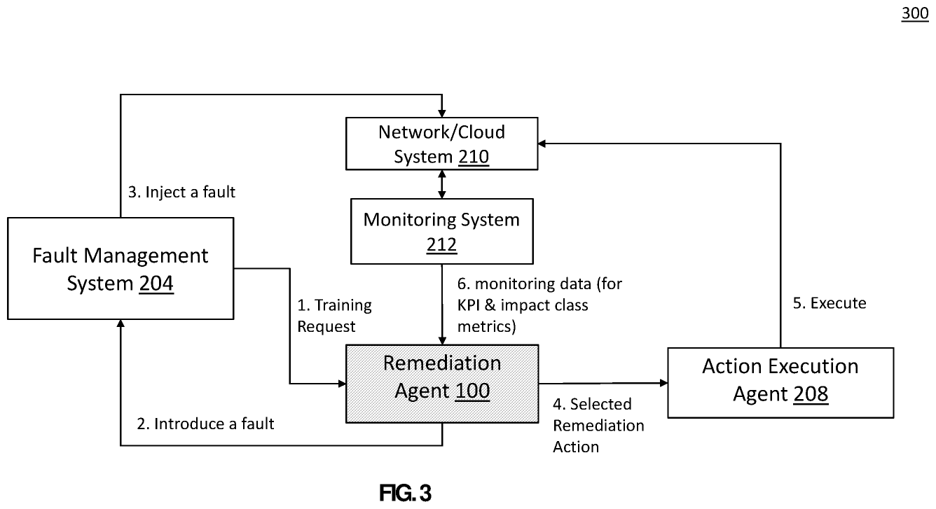

FIG. 3 illustrates operations of a deployment architecture in which a remediation agent operates in offline training mode per some embodiments. The deployment architecture software modules and/or hardware logic in a system 300 comprises the software modules and/or hardware logic in system 200 as shown in FIG. 2. The steps shown with numeric numbers 1 to 6 indicate the order of operations in one embodiment.

The process starts when the fault management system 204 sends a training request to the remediation agent 100 at step 1. In the request, the input parameters include a set of faults and an RCA path (if available), a set of possible remediation actions, and a remediation policy. The remediation agent 100 may start a selection process for each fault. During the process, the remediation agent 100 may try a selected action in order to calculate its execution score Sₐ, explained in further detail below. This includes requesting (1) fault management system 204 to introduce a specified fault (a fault in the set of faults) at step 2; (2) fault management system 204 to inject the specified fault to the network/cloud system 210 and perform root cause analysis (RCA) if a root cause path of the fault is unknown at step 3; (3) the action execution agent 208 to receive the selected action at step 4; and (5) the action execution agent 208 to execute the selected action on the network/cloud system 210 at step 5. Finally, the monitoring system 212 evaluates the selected action by analyzing the collected monitoring data collected at step 6, similar to the operation by the same entity in FIG. 2.

Note that steps 2 to 6 may be repeated multiple times for each action selection process. The result of the training may be a fault/action binding record created for each fault in the fault/action binding memory. In case there are no bindings found after trying all the actions for a given fault, the remediation agent 100 may return a binding failure for the fault, which may trigger a remediation policy change or a human intervention.

In these adaptive fault remediation solutions using online remediation and offline training and based on a remediation agent, the remediation agent executes the action selection in some cases using an existing knowledge from a fault/action binding memory, while in other cases using one or more action selection agents to learn the knowledge of fault/action binding if there is no existing knowledge. After one or more actions are selected, the remediation agent may call for executing one or more actions and collect the monitoring data to evaluate the effectiveness of the one or more actions. Only the actions that have positive influence in healing the network/cloud system may be maintained in the fault/action binding for future use.

In some embodiments, the action selection agent selects an action based on the distance between an action and a fault, where the distance is calculated according to (1) the distance between the system component on which the action is operated and the root cause system component in the root cause path, (2) the effectiveness in healing the cloud system after executing the action, and (3) the resource and time required for executing the action.

Further details of the operations relating to automatic selection of one or more actions for remediating a detected or predicted fault in some embodiments are discussed herein below.

### Terms

While terms used herein are to be interpreted according to their ordinary meaning in the relevant technical field in general, some terms have specific meanings in some embodiments, and they are discussed herein below.

### Fault and Root Cause Analysis (RCA) Path

A “fault” can be any event that occurs in a network resulting in negative effects. In some embodiments, faults are referred to as those events that could result in a service (e.g., application service and/or network/cloud application) interruption or performance degradation. A fault may be detected once it occurs or predicted before it happens.

In some embodiments, a fault can be described in a format as the following: Fault: (application: fault ({type, parameters}), fault_time, time_stamp), where:
(i) The “application” describes the application in question, such as Robot Shop Web application, 5G core service, and mixed reality (XR) simultaneous localization and mapping (SLAM) application;
(ii) The “fault” specifies the problem of the application, and it includes a fault type and a set of fault parameters. For example, a throughput violation fault={type: “throughput below threshold”, parameters: {“threshold=100”, “throughput=70”}};
(iii) The “fault_time” describes the time when the problem occurs. If the time is larger than the time_stamp, it means that the fault is a predicted fault, whereas if the two times are equal, it means that the fault is a detected fault; and
(iv) The “time_stamp” is the time when the problem is reported.

An exemplary fault, a predicted KPI violation, may be expressed as the following: web_fault_1=(“robot_shop”: {type: “response time exceeding threshold”, parameters: {“threshold=1s”, “response time=1.1s”}}, 1655472562, 1655472502), meaning that the response time of the web app “robot_shop” may exceed the threshold by 0.1 second in next 60 seconds (a predicted fault).

“Root Cause Analysis (RCA)” Path describes the root cause analysis result for a specific fault. It can be presented in a format as the following: RCA Path: (fault: Fault, path: [{system_component: impact_class ({type, parameters})}]), where:
(i) The “fault” is identical to the above-defined fault;
(ii) The “path” describes a list of impacted system components and their impact classes, where an “impact class” represents a class of symptoms on a type of system component. It includes a type and a set of parameters, in the same format as a “fault”. For instance, impact1={type: “not enough resource”, parameters: {“demand=50%”, “actual=30%”}}, impact2={type: “high CPU utilization”, parameters: {“threshold=80%”, “usage=95%”}}, and impact3={type: “high packet loss”, parameters: {“threshold=1%”, “loss rate=10%”}}. In some embodiments, the path may describe the system components that could cause (for a predicted fault) or have caused (for a detected fault) the fault.

The sequence of elements in the “path” list reflects the sequence of the impacted components. The last item in the list represents the potential root cause of the fault in some embodiments.

An exemplary RCA path, a web fault, may be expressed as the following: rca_web_fault_1=(fault: web_fault_1, path: [{“container: frontend”: impact1}, {“container: payment”: impact3}, {“device: server1”: impact2}]). In this example, the root cause is that server1 has a CPU utilization over the threshold of 80% and that the fault impacts two system components: the payment container to have a loss rate of 10%, and the frontend container to have only 30% of the resource.

### Remediation Policy and Actions

A “remediation policy” specifies the time and resource constraints for a remediation process. It may be provided by a network/cloud operator. Examples are time <60 seconds (thus the remediation action is required to be finished within 60 seconds) and resource <10% of the CPU load. The policy may also include a time priority of the remediation, such as “urgent” and “normal”, and some application reliability requirements, such as QoS fulfilled in 99.99% of time. In some embodiments, the time priority of the remediation may be a specific time duration (instead of categories like urgent and normal), based on which the remediation agent determines how soon the remediation action(s) are to be performed and in which manner (e.g., concurrent or sequential performance). Additionally, the priority of remediation in the policy may not be timing related but resource related, e.g., one or more computing/bandwidth/storage resource constraints may be considered a “high” priority (perhaps at the same level as “urgent” to timing requirement). These constraints may include a set of allowable remediation actions as well.

“Remediation actions” are lists of actions that can be operated on specific system components. They can be provided by different parties. For examples, the application actions can be provided by the application developer, the virtual machine (VM), container, load balancer, and pod related actions can be provided by a cloud platform provider, and the host device and network actions can be provided by network/cloud operator or another infrastructure provider. Examples of possible actions on system components, from an application to a network, are the following:
Application: traffic control, reconfiguration, restart, kill+start, check point roll back;
Container: restart, migrate, reconfiguration, duplicate;
Load balancer: reconfiguration, restart;
Pod: restart, migrate, scale out, scale up;
VM: restart, scale out, migrate, scale up;
Device: restart, reboot, reconfiguration; and
Network: link reset, scale out, traffic redirection, reconfiguration.

Note that an action can be mapped onto commands together with some parameters. In some embodiments, the term is used in the place of “device” and both referring to an electronic device on which an application is executed.

### Fault/Action Binding

A “fault/action binding” facilitates remediation action selection process. A fault/action binding record may map one fault to one or more actions. The records of fault/action bindings may be stored as objects/entries in a variety of data structures, each object/entry may be as a map, a dictionary, a list, an array, a file, and/or a table. In some embodiments, the object/entry may contain one or more attributes and methods as the following:

### Attributes

Fault type: the type of a fault to handle;
Tuple list: [(system component, impacted class type, action, distance)], where the tuple maintains an action and its distance to the fault, together with the impact class and the system component that the action is healing; and
Timer: represent the freshness of the binding, where an expired binding may be deleted from the memory and to avoid frequent binding changes, the timer can be set to a relatively long value, e.g., 6 months or 1 year.

### Methods

Create: create a binding record;
Update: update tuple list, including updating an action and its distance in the list; and
Reset timer: called each time when the update method is called.

### Score and Distance Functions

A “score” (also referred to as an “execution score”) of an action (also referred to as an action score) may be calculated and updated after each time an action is executed. A score increases when an action is successfully executed to remediate the fault and decreases otherwise. A score of an action may be determined by one or more of three factors in some embodiments: 1) historical score, 2) current execution result, and 3) the cost of the action.

In some embodiments, the score is defined by a score function below:

$${S}_{a} = β * {S}_{a \_ history} + ( 1 - β ) * ( x * {R}^{k} + y * {\sum }_{j = 1}^{n} α * {R}^{j} + z * {R}^{p} ) / {C}_{a} \qquad ( 1 )$$

In Formula (1), S represents a score; and Sₐ and S_{a_history} represent the current and historical scores of an action for a given fault, respectively;
R represents the evaluation result for an action execution effectiveness (e.g., success→1 or fail→−1), where R^{k} represents the effectiveness for healing the detected/predicted fault, (e.g., a KPI for an application), R^{j} represents the effectiveness for healing the impact on the system components in the RCA path, “j” represents one impact class, and “n” represents the total number of impacted components in the RCA path; and R^{p} represents the effectiveness for remediation policy fulfillment.

The variables x, y, and z represent the weight factor of each effectiveness evaluation, where x+y+z=1. The variable α is the parameter representing the serious status of an impact, where 0<α<1; and the variable β is the historical impact factor where 0<β<1. Cₐ is the estimated cost for an action, and it is determined by the resource usage, time of execution, and impact to environment (the network/cloud in which the remediation action is performed). The cost of an action can be provisioned by the action providers before an action is executed.

A “distance” between an action and a fault is based on a score Sₐ of the action and a distance weight, D_{w} in some embodiments. The higher a score, the shorter the distance is and more relevant the action to the fault. In some embodiments, the distance is defined by a distance function Df below:

$$\begin{matrix}Df = {D}_{w} / {S}_{a} & Sa > 0 \\ Df = - {D}_{w} & Sa \leq 0\end{matrix} \qquad ( 2 )$$

In Formula (2), D_{w} may be determined by the position of an impacted system component in the RCA path. For example, an action for healing a root cause component can have a weight 1, the component next to the root cause has a weight 2 and so on. When Sₐ is zero or a negative value, Df is set to a negative value.

While specific formulas are given as examples of how the execution score and distance are calculated, the score function and distance function may be defined differently in some embodiments. Note that the score or distance function are used for action selection, the operations of which are inspired by clonal selection methods in an artificial immune system per some embodiments.

### Artificial Immune System (AIS) and Clonal Selection

Artificial Immune Systems (AIS) are a class of computationally intelligent, rule-based machine learning systems inspired by the philosophies and procedures of the biological immune system. The algorithms are typically modeled after the learning capabilities of the immune system together with its memory for use in problem-solving. The biological immune system is diverse, distributed, dynamic, and error tolerant, which makes it highly complicated and appears to be precisely tuned to the problem of detecting and eliminating infections. It is also adaptable in learning to recognize and respond to new infections and retaining a memory of those infections to facilitate future responses. In addition, immune system is autonomous in that there is no outside control required. All these characteristics make AIS an active research area for solving complex problems.

As one class of AIS studies, clonal selection methods (also referred to clonal selection algorithms) as are inspired by the clonal selection theory that explains how B-cells (that produce antibodies of a specific configuration) improve their response to antigens over time called affinity maturation. The diversity is stimulated upon encounter with a foreign antigen, where the resulting B-cell clones vary the antibody configuration to perform a biological local search to find the best-fitting antibody. The process of repeated filtering of candidate solutions in the form of antibody populations results in a type of optimization. Clonal selection methods have produced solutions that tend to be the most robust, though not necessarily the most optimal. This makes them particularly suited for more complex optimization problems such as multi-objective optimization. AIS and clonal selection have been explained in references such as “Architecture for an Artificial Immune System,” by Steven A. Hofmeyr et al., dated Apr. 25, 2000, and “Artificial Immune System,” by Julie Greensmith et al., dated Jun. 25, 2010. Briefly, a clonal selection includes the following operations: randomly initialize pool of antibodies; expose the pool to antigen, repeat until termination criteria are met—1) clonal selection (e.g., based on Euclidean distance between antigen and antibody), 2) clonal expansion, and 3) somatic hypermutation.

The adaptive fault remediation takes inspiration from the clonal selection method. An antigen can be mapped onto a fault and an antibody mapped onto a remediation action. Initially, actions are placed around the fault randomly or by an incremental action cost. The distance between an action and a fault is calculated after testing (e.g., reproduce the fault, apply the action, and evaluate the effectiveness).

The action selection may be done in multiple rounds. In each round, the action with the highest execution score is selected, and its distance is compared with the shortest distance from the previous rounds. Only the action with the shortest distance to the fault may be saved. The next round of selection may be performed with only the affinity actions to the previous selected action (which simulates the clone and somatic hypermutation). The selection termination criteria may be set in a variety of ways, e.g., the selection converged to one action for more than a number of times, or a maximum number of rounds reached.

### Operations of a Request Handler Per Some Embodiments

As shown in FIG. 1, a request handler within a remediation agent may receive two types of requests, and the two subsections below discuss operations of handling training and remediation requests respectively.

### Handle Training Request

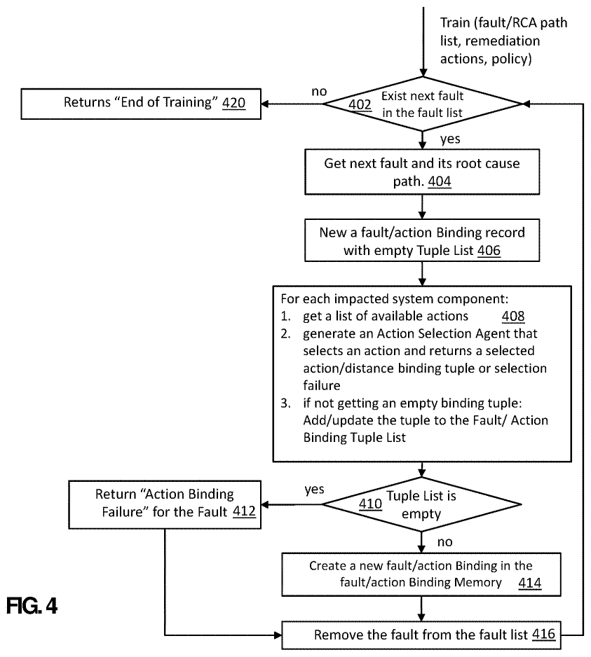

FIG. 4 illustrates operations of handling a training request per some embodiments. The operations are performed by request handler 112 in some embodiments. In the training process, a request handler targets to find the best action(s) for each fault and creates a binding in the fault/action binding memory. To do this, the request handler may create multiple action selection agents, each for one impacted system component in the RCA path of the fault. The action selection agent may perform the action selection based on a clonal selection method in some embodiments.

At reference 402, a training request is received with parameters indicating (1) a list of faults and their RCA paths, (2) remediation actions, and (3) a remediation policy. The training request handler determines whether all of the faults in the list have been examined, and if so, an end of training message is returned, and the process completes at reference 420. Otherwise, the process continues at reference 404, where the next fault in the list and its root cause path are examined. A new fault/action binding record is created with an empty tuple list at reference 406.

At reference 408, for each impacted system component in the RCA path of the fault, the request handler (1) gets a list of available actions for the system component, (2) generates an action selection agent (e.g., the action selection agent 114) that selects an action and returns a selected action/distance binding tuple, or returns a selection failure when no action is available for the fault (e.g., no action would satisfy the remediation policy); (3) adds a fault/action binding tuple for the fault in the fault/action binding tuple list or updates when the action/distance binding tuple is not empty.

At reference 410, it is determined whether the tuple list is empty. If not empty, the new/updated fault/action binding tuple is created/updated as a record for the new fault/action binding (or the updated fault/action binding) in the fault/action binding memory at reference 414. If empty, the selection failure is returned as an “Action Binding Failure” for the fault at reference 412. Either way, the fault is removed from the to-be-examined fault in the list of faults, and the operation returns to reference 402.

When there is no action selected for a fault (a selection failure is returned), the request handler may report to the fault management system for further investigation, which may include changing policy, adding new actions, or human intervention.

After training, the remediation agent can be used for online inferencing, for example for handling remediation requests. The fault/action binding records may evolve while running online, and the training may also be executed from time to time, e.g., when there is a major network/cloud environment change, such as hardware, cloud management software, and application changes that generate new type of faults, or when an existing binding no longer works.

### Handle Remediation Request

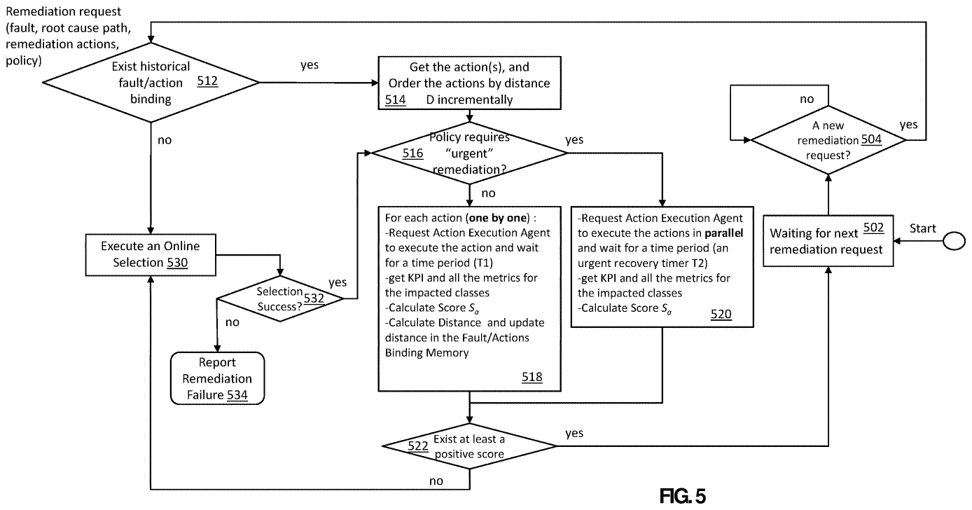

FIG. 5 illustrates operations of handling a remediation request per some embodiments. The operations are performed by request handler 112 in some embodiments. The operations start at reference 502, which waits for the next remediation request, and when no new remediation request is received, the flow waits at reference 504. When a new remediation request arrives, the flow goes to reference 512. Similar to the training request in the training mode, the received remediation request includes parameters indicating (1) a fault and its RCA path, (2) remediation actions, and (3) a remediation policy in some embodiments.

At reference 512, the request handler first examines if there is a historical binding record in the fault/action binding memory. If yes, it may get the action(s) in the historical binding record, trigger action executions, and update the distances after executions. When multiple actions are mapped to the fault, the actions may be ordered by distances incrementally from the shortest to the longest at reference 514. Note that the remediation policy may indicate a priority of each action (e.g., normal or urgent remediation). The request handler may determine the priority of each action at reference 516.

If the remediation is not urgent (or high priority), the flow goes to reference 518, where the multiple actions (when the binding includes them) mapped to the fault in the historical binding record are executed by an action execution agent (e.g., the action execution agent 208) one by one in sequence. In some embodiments, the request handler may initiate a timer to set a time limit T1 on how long the execution may be performed, and each action may be mapped to a different T1 time period. The request handler may call the action evaluator 110 to get KPIs and all metrics for system components in the impacted classes and calculate the execution score Sₐ based on execution (e.g., the score may be computed using a score function such as the one shown in Formula (1)). The distance between the action and the fault may also be calculated (e.g., using a distance function such as the one shown in Formula (2)). The calculated distance is then used to update the historical binding record (e.g., the one in the tuple list) in the fault/action binding memory in some embodiments.

If the remediation is urgent (or high priority), the flow goes to reference 520 and the multiple actions (when the binding includes them) mapped to the fault in the historical binding record are executed by an action execution agent (e.g., the action execution agent 208) in parallel to quickly heal the system. The request handler may initiate a timer to set a time limit T2 on how long the concurrent execution may be performed in some embodiments. The request handler may call the action evaluator 110 to get KPIs and all metrics for system components in the impacted classes and calculate the execution score based on execution (e.g., the score may be computed using a score function such as the one shown in Formula (1)). While the score reflects the efficiency of the concurrent execution of the multiple actions in remediating the fault, it does not reflect the real result of a particular action within the multiple actions because the multiple actions may affect each other. Thus, the distance may not be updated in the corresponding record in the fault/action binding memory in some embodiments.

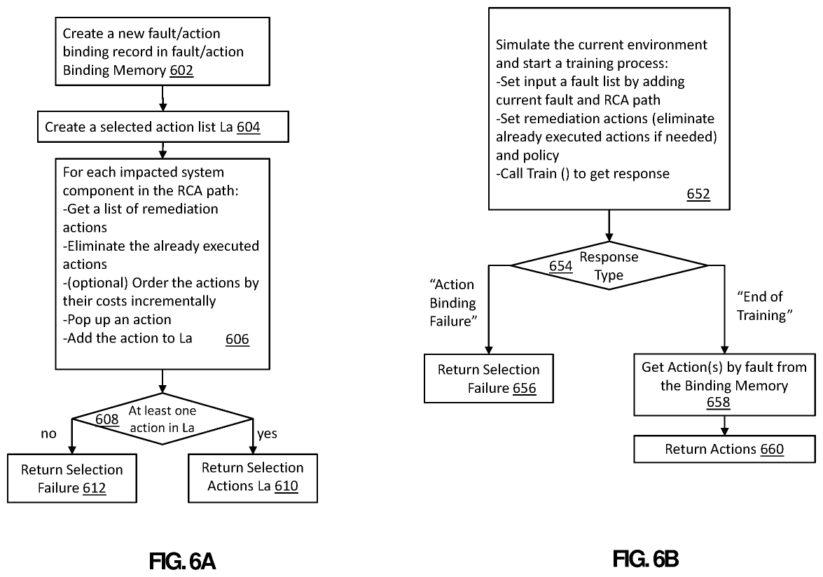

Both branches of the execution then reach reference 522, and if at least one positive score is derived based on the execution, the flow goes back to reference 502. Otherwise, all the actions in the binding result in negative scores, meaning a remediation failure and no historical binding record include actions to remediate the fault. The flow goes to reference 530, where an online selection of action to remediate the fault is executed at reference 530, which includes the operation that the flow also reaches when no existing historical fault/action binding record exists for the fault. The online selection is explained in further details in FIG. 6.

At reference 532, the request handler determines whether the selection is successful (e.g., identifying one or more actions to perform), and the selected action(s) may be evaluated based on action priority at reference 516. Otherwise, the request handler reports a remediation failure at reference 534.

FIGS. 6A-6B illustrate operations of two online learning approaches to handle a remediation request per some embodiments. Either or both approaches may be used for the online selection at reference 530.

FIG. 6A illustrates a trial-and-error approach in some embodiments. At reference 602, a request handler creates a new fault/action binding record in the fault/action binding memory. At reference 604, the request handler creates an empty selected action list (La). For each impacted system component in the RCA path included in a remediation request, the request handler may, at reference 606, (1) get a list of remediation actions, (2) eliminate the already executed action, (3) optionally order the remaining actions by their costs incrementally, and (4) pop up an action in the remaining actions and add it to the selected action list (La).

Then at reference 608, the request handler may determine whether the selected action list (La) includes at least one action. If so, the flow goes to reference 610, and the non-empty selected action list (La) is returned; otherwise, the flow goes to reference 612, where selection failure returns at reference 612. Note, with the optional action ordering, the online selection of actions is done based on cost; and without it, the online selection is done randomly. Either way, the remediation agent may gradually learn the best action, and the learned fault/action binding may be recorded as the new fault/action binding record in the fault/action binding memory.

FIG. 6B illustrates a simulation-and-training approach in some embodiments. At reference 652, the request handler simulates the current environment of the network/cloud system for which remediation actions are requested and starts a training process. The training may (1) set input with a fault list by adding current fault and an RCA path, (2) set one or more remediation actions (after eliminating already executed actions if needed) and policy, and (3) call a train( ) function to get response. The simulation may be performed by a “digital twin” or “backup” system that can simulate current live environment.

At reference 654, the request handler determines the response type. If the response is “end of training,” the action(s) derived from the training is mapped to the fault at reference 658, and the action is returned at reference 660. If the response is “action binding failure” (or any other types of failures), a selection failure is returned at reference 656. Note that the train( ) function may include the similar process defined in FIG. 4, where an action selection agent 114 are initiated, which may use methods such as clonal selection method to handle a training request as discussed earlier in this section.

### Operations of an Action Selection Agent Per Some Embodiments

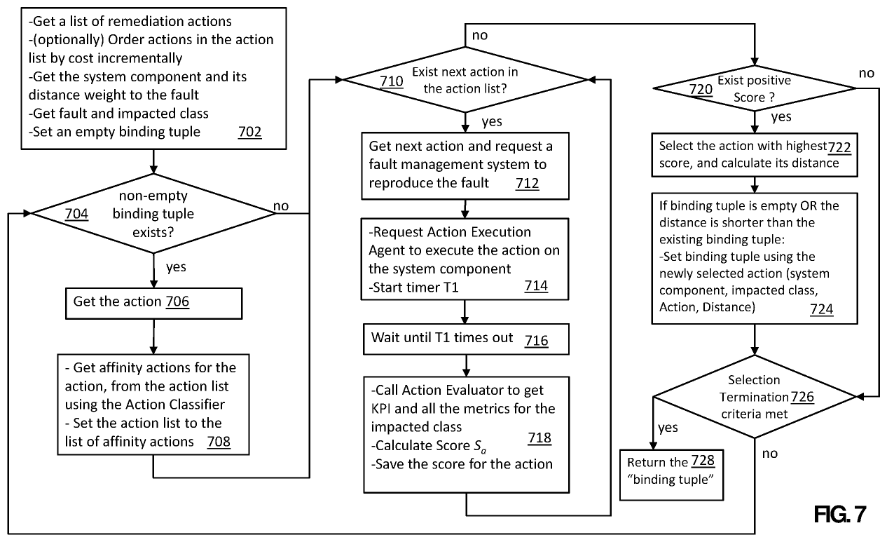

As shown in FIG. 1, an action selection agent within a remediation agent may select actions for a fault. FIG. 7 illustrates operations of an action selection agent to select actions per some embodiments. The operations are performed by action selection agent 114 in some embodiments.

At reference 702, the action selection agent may (1) get a list of remediation actions for a fault from a remediation request, (2) optionally order the remediation actions in an action list by cost from low to high incrementally, (3) get the system component and its distance weight to the fault based on the fault, (4) get the fault and impacted class(es) based on the fault, and (5) set an empty binding tuple for the fault (in software implementing the setting, the function may be “new” the empty binding tuple for the fault).

At reference 704, it is determined whether a non-empty binding tuple for the fault exists in the fault/actions binding memory 118. If such non-empty binding tuple exists, the action is obtained from the tuple at reference 706. The action selection agent may then get affinity actions for the action (actions belonging to the same class of the action) from the action list using an action classifier (e.g., action classifier 116), and set the action list to the list of affinity actions (e.g., inserting each action from the affinity actions to the action list) at reference 708. Both branches then reach reference 710, where whether the action list has any next action to be examined.

If the action list is not exhausted, the flow goes to reference 712, where the action selection agent may get the next action and request a fault management system (e.g., fault management system 204) to reproduce the fault (a fault may be reproduced in various ways, e.g., using some tools to add workloads to the system or introducing packet loss). The operation is usually done offline where the action selection agent can test and evaluate an action in order to make an action selection.

At reference 714, the action selection agent may request an action execution agent (e.g., action execution agent 208) to execution the action on the corresponding system component, and the execution may be timed by a timer (T1). At reference 716, the selection agent waits until the timer times out. Afterward, the action selection agent may call an action evaluator (e.g., action evaluator 110) to get KPIs and all metrics for system components in the impacted classes, calculate the execution score Sₐ, and save the score for the action at reference 718. The flow goes back to reference 710 to examine the next action in the action list.

If the action list has been exhausted, the flow goes to reference 720 to determine whether a positive score is obtained. If not, the flow goes to reference 726 to determine whether one or more selection termination criteria are met. If a positive score is obtained, the flow goes to reference 722, the action selection agent may select the action with the highest score and calculate its distance to the fault at reference 722. If the binding tuple is empty or the calculated distance is shorter than the score in the existing binding tuple, the action selection agent may set the binding tuple using the newly selected action at reference 724. The binding tuple may be in the form of [(system component, impacted class type, action, distance)] as discussed herein above. The flow then reaches reference 726 to determine whether one or more selection termination criteria are met. When the criteria are met, the flow goes to reference 728, where a binding tuple is returned. Otherwise, the flow goes back to reference 704 for a new round of selection.

### Operations Relating to a Fault/Action Binding Memory Per Some Embodiments

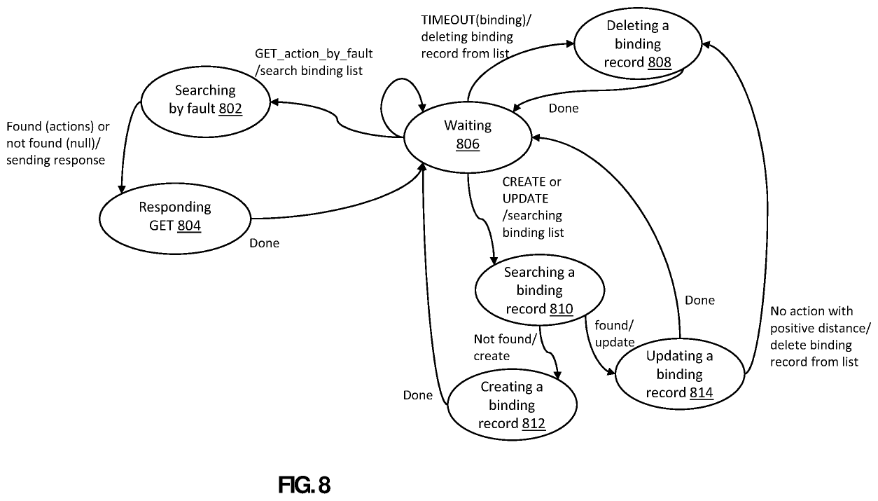

A fault/action binding memory stores and maintains a list of fault/action binding records (referred as binding list). The fault/action binding memory can receive “get”, “create” or “update” requests from a request handler. It is also responsible for deleting an action from a binding record if the action has a negative distance to a fault, which means that the action has a zero or negative execution score. In addition, it deletes a binding record when the binding times out. FIG. 8 illustrates a state machine of a fault/action binding memory per some embodiments.

At reference 802, the fault/action binding memory may be searched by fault, since the fault/action binding records include the fault type in their attributes. The search (to search the binding list) may be triggered by an operation to “get” corresponding remediation actions based on the fault (included in a remediation request). Based on one or more actions being found or not found, the fault/action binding memory may respond to the “get” at reference 804 and the fault/action binding memory then returns to the waiting state at reference 806.

The fault/action binding memory may stay in the waiting state until a timeout by a timer, expiration of which causes deletion of a binding record at reference 808. Such deletion based on staleness of a binding record makes the fault/action binding memory to not waste storage space for binding records that likely won't be relevant anymore.

The fault/action binding memory may move to search binding records state at reference 810 upon receiving the request of “create” or “update” the searching binding records. When a requested binding record is found and in need of an update, the record may be updated at the updating binding record state at reference 814. When the binding record does not return a positive distance, the binding record is deleted. When the requested binding record is not found and in need of creation, a new binding record is created at reference 812.

### Operations Per Some Embodiments

Embodiments of the invention describe remediation agent-based solutions to remediate fault in a network, including cloud system and/or wireless/wireline networks. Briefly, the remediation agent may receive a remediation request when there is a detected/predicted fault in a network, and the remediation agent may then select one or more actions based on the distance between an action and a fault, and request remediating the fault use the selected one or more actions. The effectiveness of the one or more actions may then be evaluated by calculating an execution score after an action execution. A fault and action(s) binding record may then be created if the action(s) are effectively healing the faulty system component(s) and/or impacted system component(s), and a fault/action binding record may be updated after each time the network is remediated with the given fault.

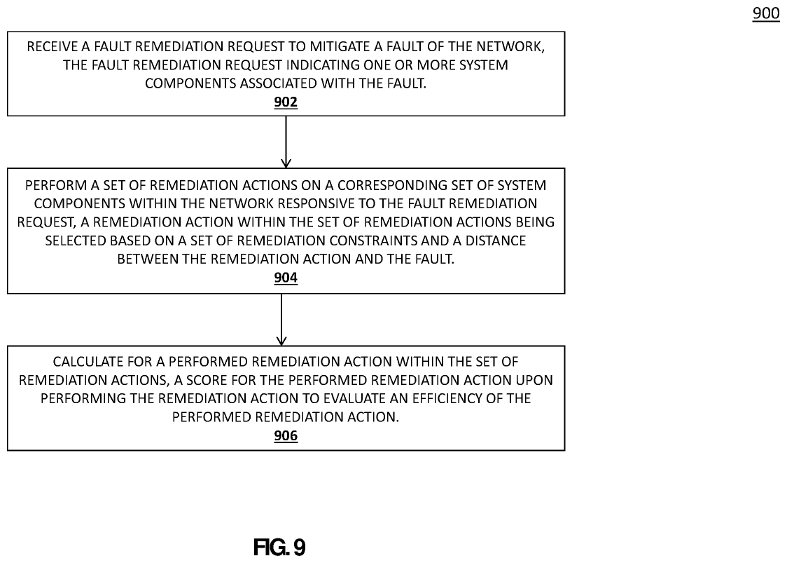

FIG. 9 is a flow diagram illustration of the operations to implement adaptive fault remediation in a network per some embodiments. The operations may be performed by an electronic device including a remediation agent (e.g., remediation agent 100) discussed herein.

At reference 902, the remediation agent receives a fault remediation request to mitigate a fault of the network, the fault remediation request indicating one or more system components associated with the fault. The one or more system components are the ones impacted by the fault and/or could have caused the fault in some embodiments.

At reference 904, the remediation agent performs a set of remediation actions on a corresponding set of system components within the network responsive to the fault remediation request, a remediation action within the set of remediation actions being selected based on a set of remediation constraints and a distance between the remediation action and the fault. At reference 906, for a performed remediation action within the set of remediation actions, the remediation agent calculates a score for the performed remediation action upon performing the remediation action to evaluate an efficiency of the performed remediation action.

In some embodiments, the distance between the remediation action and the fault is determined based on a weight for the remediation action and a score for the remediation action. The weight for the remediation action is based on closeness of the remediation action to the one or more system components associated with the fault. For example, the distance may be calculated based on Formula (2) above or other ways that a distance function may be formulated as discussed herein above.

In some embodiments, the score for the remediation action is based on a historical score for the remediation action to mitigate the fault, effectiveness for the remediation action on the fault, on the one or more system components, and on the set of remediation constraints, and cost of the remediation action. For example, the score may be calculated based on Formula (1) above or other ways that a score function may be formulated as discussed herein above.

In some embodiments, the set of remediation actions are performed sequentially, while a first remediation action is performed earlier than a second remediation action when a first distance between the first remediation action and the fault is less than a second distance between the second remediation action and the fault.

In some embodiments, the set of remediation actions are performed concurrently based on a priority of the fault. The priority of the fault may be determined based on a remediation policy discussed herein above.

In some embodiments, the one or more system components comprise a set of system components impacted by the fault and the fault remediation request identifies corresponding impact classes of the set of system components.

In some embodiments, the set of remediation constraints comprises one or more of a set of allowable remediation actions, a time duration during which the set of remediation actions are to be performed, a set of allowable computing resources to be consumed by the set of remediation actions, a set of allowable bandwidth or storage resources to be consumed by the set of remediation actions. These remediation constraints may be included in a remediation policy discussed herein above.

In some embodiments, a binding record is created between the remediation action and the fault based on the score, and wherein the binding record is stored to be used by future fault remediation requests. In some embodiments, the binding record is stored in a storage with a freshness indication to identify one or more conditions to remove the record from the storage. The condition may be expiration of a timer to count the time period that the binding record has been in the storage (e.g., the fault/action binding memory) and has not been updated.

Through embodiments of the invention discussed herein, the performed one or more remediation actions do not only remediate a faulty system component, but also heal the impacted system components. Multiple remedial actions may be applied to different system components at the same time or one by one in some embodiments, and the probability of the remediation success is greatly increased compared to earlier approaches. Additionally, resource and time usage of a remediation action is considered as part of the criteria for evaluating the effectiveness of the remediation action as shown in the execution score and distance determination. This allows an operator to set specific policy for a remediation in a specific network/cloud system, so that the remediation can be adaptive to the current environment. Furthermore, embodiments allow automatically and continuously learning the knowledge of the best remediation action(s) for healing/mitigating a given fault. Through creating a binding between a fault and action(s), the knowledge may be saved for future use. Additionally, the knowledge can further be shared among other network/cloud system operating at similar environments. This can help in reducing the cost and time used for searching remediation actions and provide operating expense (Opex) efficiency.

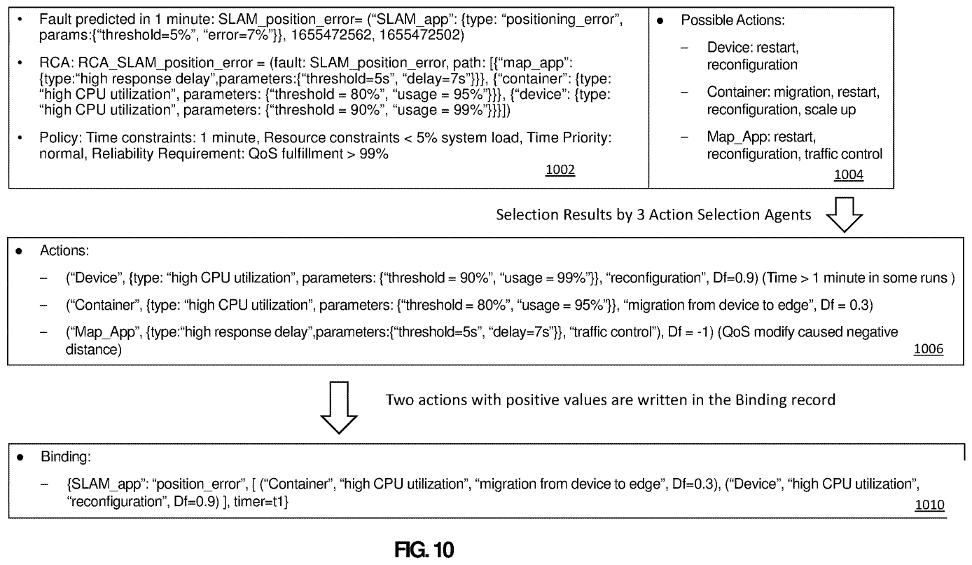

FIG. 10 illustrates an example of a remediation process per some embodiments. A remediation agent receives a remediation request as shown at reference 1002 (e.g., through the request handler 112) and a list of possible actions as shown at reference 1004 may be selected based on the remediation request (e.g., by the action selection agent 114). Note that the fault of SLAM position error has an RCA path including multiple impacted system components: application (map_app), container, and device.

The remediation agent determines execution scores and corresponding distances of each possible action (e.g., through three instances of the action selection agent 114) at reference 1006. The actions on the device and container result in positive distances, while the one on the application results in a negative distance, thus the remediation action on the application is eliminated, and the remaining two remediation actions are performed, and their corresponding fault/action binding records are created or updated at the fault/action binding memory.

### Devices Implementing Embodiments of the Invention

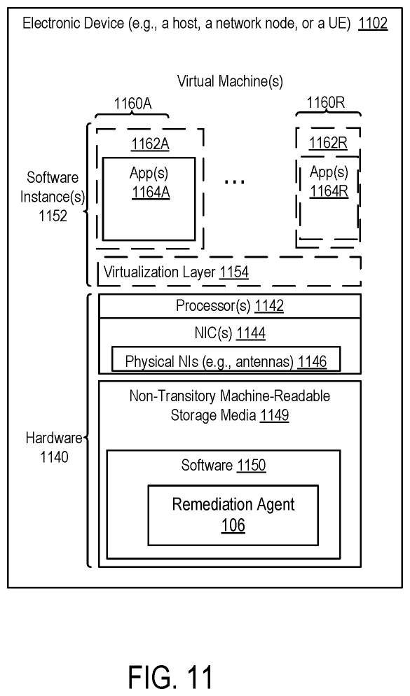

FIG. 11 illustrates an electronic device implementing adaptive fault remediation per some embodiments. The electronic device may be a host in a cloud system, or a network node/UE in a wireless/wireline network, and the operating environment and further embodiments the host, the network node, the UE are discussed in more details herein below. The electronic device 1102 may be implemented using custom application-specific integrated-circuits (ASICs) as processors and a special-purpose operating system (OS), or common off-the-shelf (COTS) processors and a standard OS. In some embodiments, the electronic device 1102 implements remediation agent 100.

The electronic device 1102 includes hardware 1140 comprising a set of one or more processors 1142 (which are typically COTS processors or processor cores or ASICs) and physical NIs 1146, as well as non-transitory machine-readable storage media 1149 having stored therein software 1150. During operation, the one or more processors 1142 may execute the software 1150 to instantiate one or more sets of one or more applications 1164A-R. While one embodiment does not implement virtualization, alternative embodiments may use different forms of virtualization. For example, in one such alternative embodiment, the virtualization layer 1154 represents the kernel of an operating system (or a shim executing on a base operating system) that allows for the creation of multiple instances 1162A-R called software containers that may each be used to execute one (or more) of the sets of applications 1164A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 1154 represents a hypervisor (sometimes referred to as a virtual machine monitor (VMM)) or a hypervisor executing on top of a host operating system, and each of the sets of applications 1164A-R run on top of a guest operating system within an instance 1162A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1140, directly on a hypervisor (in which case the unikernel is sometimes described as running within a LibOS virtual machine), or in a software container, embodiments can be implemented fully with unikernels running directly on a hypervisor represented by virtualization layer 1154, unikernels running within software containers represented by instances 1162A-R, or as a combination of unikernels and the above-described techniques (e.g., unikernels and virtual machines both run directly on a hypervisor, unikernels, and sets of applications that are run in different software containers).

The software 1150 contains remediation agent 100 that performs operations described with reference to operations as discussed relating to FIGS. 1 to 10. The remediation agent 100 may be instantiated within the applications 1164A-R. The instantiation of the one or more sets of one or more applications 1164A-R, as well as virtualization if implemented, are collectively referred to as software instance(s) 1152. Each set of applications 1164A-R, corresponding virtualization construct (e.g., instance 1162A-R) if implemented, and that part of the hardware 1140 that executes them (be it hardware dedicated to that execution and/or time slices of hardware temporally shared), forms a separate virtual electronic device 1160A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 1144. The physical network interface 1146 may include one or more antenna of the electronic device 1102. An antenna port may or may not correspond to a physical antenna. The antenna comprises one or more radio interfaces.

### A Wireless Network Per Some Embodiments

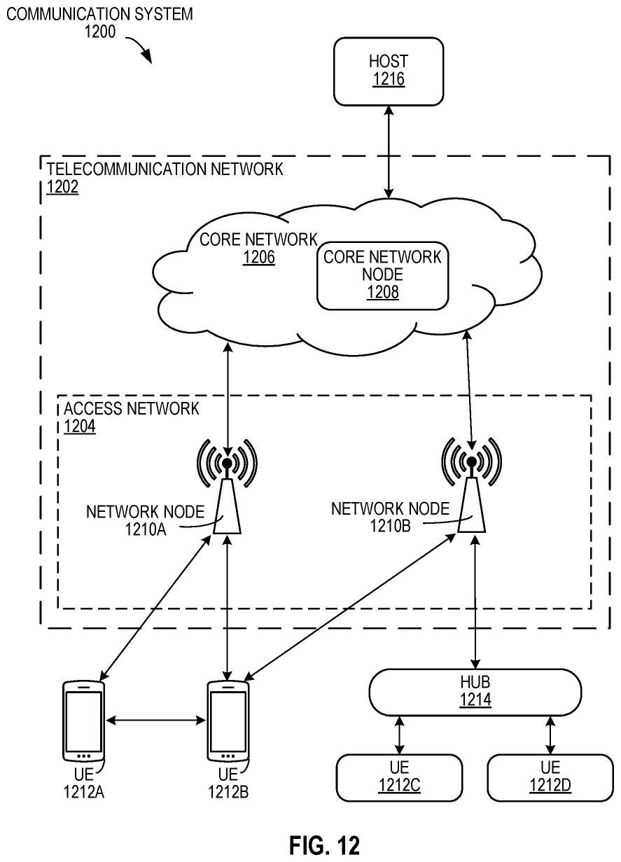

FIG. 12 illustrates an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3^{rd} Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

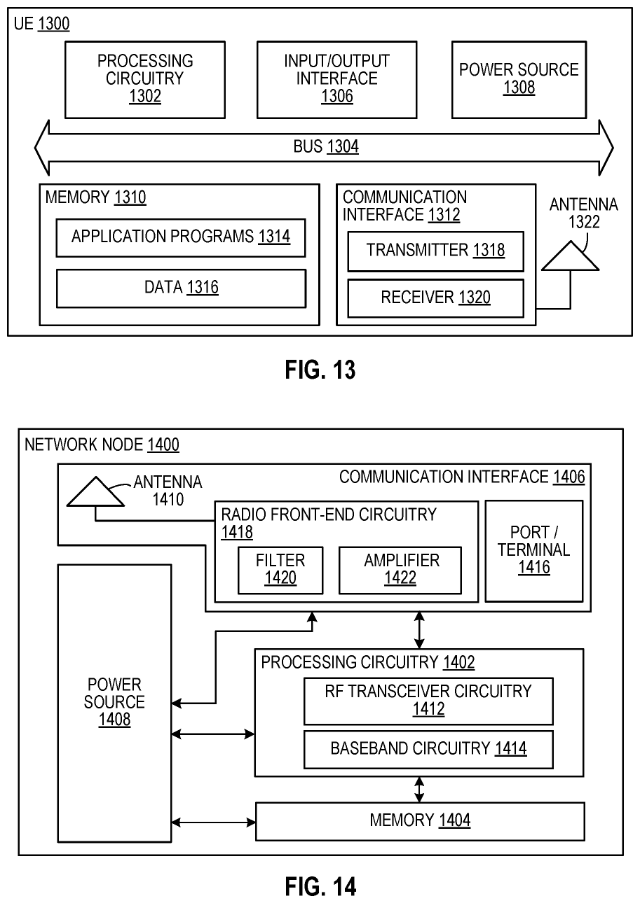

FIG. 13 illustrates a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 illustrates a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

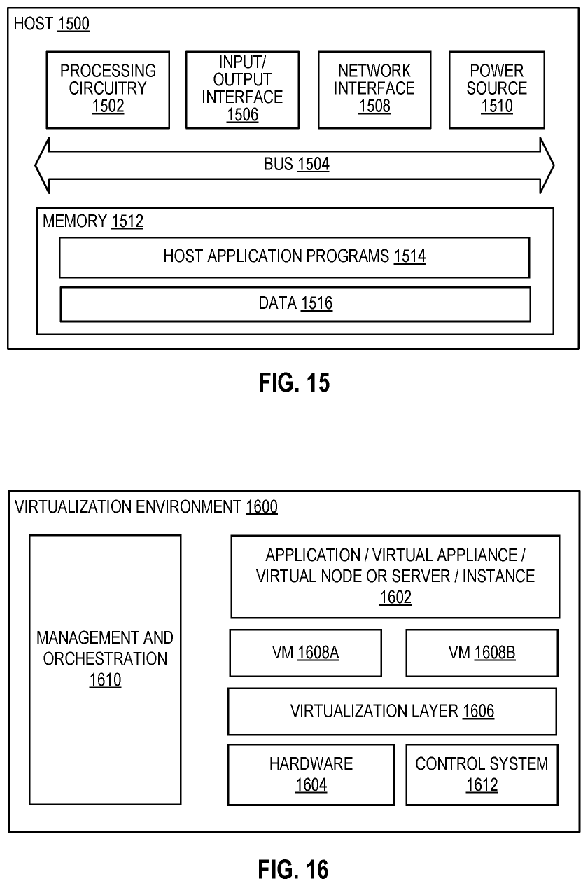

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

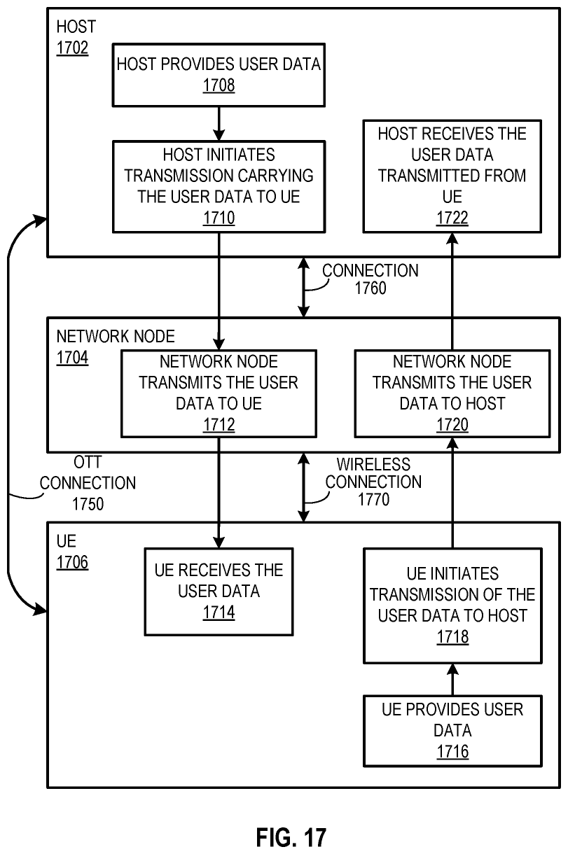

FIG. 17 illustrates a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein, refers to any positive whole number of items including one item.

An electronic device, such as electronic device 1102 and one of the computing devices discussed herein, stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals-such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to be implemented in an electronic device of a network, comprising:
receiving a fault remediation request to mitigate a fault of the network, the fault remediation request indicating one or more system components associated with the fault;
performing a set of remediation actions on a corresponding set of system components within the network responsive to the fault remediation request, a remediation action within the set of remediation actions being selected based on a set of remediation constraints and a distance as indicated by a distance function, the distance being between the remediation action and the fault; and
calculating, for a performed remediation action within the set of remediation actions, a score for the performed remediation action upon performing the remediation action to evaluate an efficiency of the performed remediation action.

2. The method of claim 1, wherein the distance between the remediation action and the fault is determined based on a weight for the remediation action and a score for the remediation action, the weight and the score being calculated in the distance function.

3. The method of claim 2, wherein the weight for the remediation action is based on closeness of the remediation action to the one or more system components associated with the fault.

4. The method of claim 2, wherein the score for the remediation action is based on:
a historical score for the remediation action to mitigate the fault,
effectiveness for the remediation action on the fault, on the one or more system components, and on the set of remediation constraints, and
cost of the remediation action.

5. The method of claim 1, wherein the set of remediation actions are performed sequentially, while a first remediation action is performed earlier than a second remediation action when a first distance between the first remediation action and the fault is less than a second distance between the second remediation action and the fault.

6. The method of claim 1, wherein the set of remediation actions are performed concurrently based on a priority of the fault.

7. The method of claim 1, wherein the one or more system components comprise a set of system components impacted by the fault and the fault remediation request identifies corresponding impact classes of the set of system components.

8. The method of claim 1, wherein the set of remediation constraints comprises one or more of a set of allowable remediation actions, a time duration during which the set of remediation actions are to be performed, a set of allowable computing resources to be consumed by the set of remediation actions, a set of allowable bandwidth or storage resources to be consumed by the set of remediation actions.

9. The method of claim 1, wherein a binding record is created between the remediation action and the fault based on the score, and wherein the binding record is stored to be used by future fault remediation requests.

10. The method of claim 9, wherein the binding record is stored in a storage with a freshness indication to identify one or more conditions to remove the binding record from the storage.

11. An electronic device, comprising:
a processor and machine-readable storage medium that provides instructions that, when executed by the processor, are capable of causing the electronic device to perform:
receiving a fault remediation request to mitigate a fault of a network, the fault remediation request indicating one or more system components associated with the fault;
performing a set of remediation actions on a corresponding set of system components within the network responsive to the fault remediation request, a remediation action within the set of remediation actions being selected based on a set of remediation constraints and a distance as indicated by a distance function, the distance being between the remediation action and the fault; and
calculating, for a performed remediation action within set of remediation actions, a score for the performed remediation action upon performing the remediation action to evaluate an efficiency of the performed remediation action.

12. The electronic device of claim 11, wherein the distance between the remediation action and the fault is determined based on a weight for the remediation action and a score for the remediation action, the weight and the score being calculated in the distance function.

13. The electronic device of claim 12, wherein the weight for the remediation action is based on closeness of the remediation action to the one or more system components associated with the fault.

14. The electronic device of claim 12, wherein the score for the remediation action is based on:
a historical score for the remediation action to mitigate the fault,
effectiveness for the remediation action on the fault, on the one or more system components, and on the set of remediation constraints, and
cost of the remediation action.

15. The electronic device of claim 11, wherein the set of remediation actions are performed sequentially, while a first remediation action is performed earlier than a second remediation action when a first distance between the first remediation action and the fault is less than a second distance between the second remediation action and the fault.

16. The electronic device of claim 11, wherein the set of remediation actions are performed concurrently based on a priority of the fault.

17. The electronic device of claim 11, wherein the one or more system components comprise a set of system components impacted by the fault and the fault remediation request identifies corresponding impact classes of the set of system components.

18. The electronic device of claim 11, wherein the set of remediation constraints comprises one or more of a set of allowable remediation actions, a time duration during which the set of remediation actions are to be performed, a set of allowable computing resources to be consumed by the set of remediation actions, a set of allowable bandwidth or storage resources to be consumed by the set of remediation actions.

19. The electronic device of claim 11, wherein a binding record is created between the remediation action and the fault based on the score, and wherein the binding record is stored to be used by future fault remediation requests.

20. (canceled)

21. A machine-readable storage medium that provides instructions that, when executed by a processor, are capable of causing the processor to perform:
receiving a fault remediation request to mitigate a fault of a network, the fault remediation request indicating one or more system components associated with the fault;
performing a set of remediation actions on a corresponding set of system components within the network responsive to the fault remediation request, a remediation action within the set of remediation actions being selected based on a set of remediation constraints and a distance as indicated by a distance function, the distance being between the remediation action and the fault; and
calculating, for a performed remediation action within the set of remediation actions, a score for the performed remediation action upon performing the remediation action to evaluate an efficiency of the performed remediation action.

22. (canceled)
